(19) United States
(12) Patent Application Publication
(10) Pub. No.: US 2014/0289742 A1
(43) Pub. Date: Sep. 25, 2014

(54) METHOD OF SHARING CONTENTS

(71) Applicant: APEX CNS Co., Ltd., Gyeonggi-do (KR)

(72) Inventors: Yongsuhk SUH, Seoul (KR); Hyongjo Kim, Gyeonggi-do (KR)

(73) Assignee: APEX CNS Co., Ltd., Gyeonggi-do (KR)

(21) Appl. No.: 14/224,970

(22) Filed: Mar. 25, 2014

(30) Foreign Application Priority Data
Mar. 25, 2013 (KR) 10-2013-0031568

(51) Int. Cl. G06F 9/54

(52) U.S. Cl. CPC G06F 9/54
USPC 719/313

(57) ABSTRACT

A method of sharing contents performed in a computing device is provided. The method includes receiving first contents stored by a first application, analyzing the first contents, extracting second contents according to an analysis result, and sharing the second contents with the second application. Even if contents are written using one application, the contents may be analyzed and then shared with other applications, and thus a user may not need to separately input contents for each application. Furthermore, the contents may be shared in a manner customized for each user, and thus, the security of contents and the task performance efficiency may improve.

### RELATED APPLICATIONS

This application claims the benefit of Korean Patent Application No. 10-2013-0031568, filed on Mar. 25, 2013, in the Korean Intellectual Property Office, the disclosure of which is incorporated herein in its entirety by reference.

### BACKGROUND

1. Technical Field

One or more embodiments of the present invention relate to a method of sharing contents, and more particularly, to a method of sharing contents between applications in order to reduce the inconvenience of a user that needs to separately input content for each application.

2. Description of the Related Art

As use of electronic devices such as computers and smart phones has considerably increased, a user may employ various applications. For example, a user may utilize an e-mail application, a memo application, a scheduling (calendar) application, an address book application, a messenger application, a task management application, etc.

For example, the user records a simple note using the memo application and records his schedule using the scheduling (calendar) application. Furthermore, the user inputs information such as a phone number and an address of a person using an address book application.

However, this input information cannot be shared between these applications.

For example, when the user takes note during a business meeting by using the memo application, and then the user needs to use the scheduling application in order to input a determined task, the task schedule, and the person in charge of the task, the user needs to send the input information to the person in charge via e-mail.

Furthermore, even when the user uses an address book application installed on his personal computer or an address book application installed on his smartphone, the user basically needs to respectively input information in the address book application on the personal computer and the address book application on the smartphone.

In order to address such an inconvenience, for example, Korean Patent Publication No. 10-2012-0107022, titled “Method and Apparatus for Synchronizing Personal Information” and filed by Samsung Electronics Co., Ltd., discloses a method of synchronizing personal information of an integrated address book with personal information of a non-integrated address book.

However, Korean Patent Publication No. 10-2012-0107022 discloses only synchronization of information between applications of the same kind, which are address book applications in this case, but does not disclose sharing information between a plurality of applications of different kinds.

### SUMMARY

One or more embodiments of the present invention include a method of sharing contents whereby contents may be shared between different applications and in a customized manner for each user when a plurality of users try to use the same content. A user may not be required to separately and additionally input contents for each application, thereby reducing the inconvenience of a user.

Additional aspects will be set forth in part in the description which follows and, in part, will be apparent from the description, or may be learned by practice of the presented embodiments.

According to one embodiment of the present invention, a method of sharing contents performed in a computing device includes: receiving first contents stored by a first application; extracting second contents to be shared with a second application from among the first contents by analyzing the first contents; and sharing the second contents with the second application.

The method may further include receiving user verification for sharing the second contents with the second application before sharing the second contents with the second application. In one embodiment, the extracting of the second contents may include analyzing the first contents according to analysis criteria including at last one of a predetermined text set, a predetermined identifier, and time information and location information provided in the computing device. In another embodiment, the extracting of the second contents may include selecting the second application according to the analysis criteria from among a plurality of predetermined applications.

At least one of the predetermined text set and the predetermined identifier may include user identification information, and the extracting of the second contents may include extracting a portion identified by the user identification information from among the first contents as the second contents.

The first application may be executed in a first computing device, and the second application may be executed in a second computing device. The sharing of the second contents may include controlling the second application to store the second contents. In one embodiment, the sharing of the second contents may include controlling the first application to store the second contents so that the second application may read the second contents.

At least one of the first application and the second application may be one of an e-mail application, a memo application, a scheduling (calendar) application, an address book application, a messenger application, and a task management application. The first application and the second application may be prepared according to a predetermined contents sharing standard. The first application may be executed in the first computing unit other than the computing device. The second application may be executed in the second computing unit other than the computing device.

### BRIEF DESCRIPTION OF THE DRAWINGS

These and/or other aspects will become apparent and more readily appreciated from the following description of the embodiments, taken in conjunction with the accompanying drawings in which:

FIG. 1 is a flowchart illustrating a method of sharing contents according to an embodiment of the present invention;

FIG. 2 illustrates a system environment in which the method of sharing contents is applied, according to an embodiment of the present invention;

FIG. 3 is a flowchart illustrating an example of operation S200 as shown in the flowchart of FIG. 1;

FIG. 4 is a flowchart illustrating another example of operation S200 as shown in the flowchart of FIG. 1;

FIG. 5 is a flowchart illustrating an example of operation S300 as shown in the flowchart of FIG. 1;

FIGS. 6 and 7 illustrate another system environment in which the method of sharing contents is applied according to an embodiment of the present invention;

FIG. 8 illustrates one embodiment of a matching relation between a first application and a second application according to the method of sharing contents according to an embodiment of the present invention; and

FIGS. 9 and 10 illustrate an example of sharing contents between the first application and the second application according to an embodiment of present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

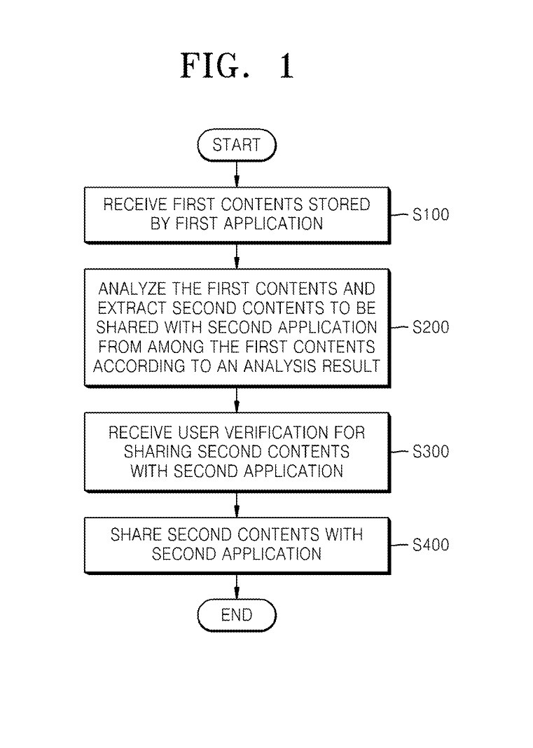

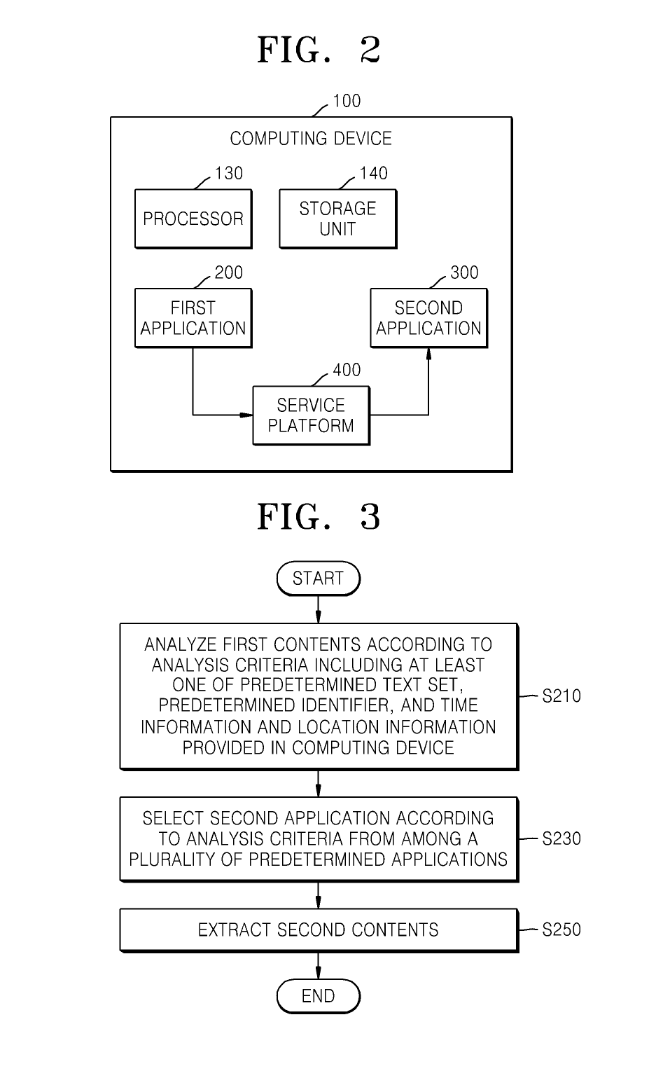

FIG. 1 is a flowchart illustrating a method of sharing contents according to an embodiment of the present invention. FIG. 2 illustrates a system environment in which the method of sharing contents is applied, according to an embodiment of the present invention. Hereinafter, embodiments of the method of sharing contents of the present invention will be described with reference to FIGS. 1 and 2.

First, a computing device 100 that implements a method of sharing contents of the present invention includes a service platform 400 for storing the method of sharing contents of the present invention. The service platform 400 receives first contents stored from a first application 200 (S100 of FIG. 1). In one embodiment, the service platform 400 may be considered as an application. In another embodiment, the service platform 400 includes a hardware component along with an application.

The computing device 100 includes a processor 130 and a storage unit 140. One of ordinary skill in the art would readily appreciate processors and storage units which are suitable to serve as the processor 130 and the storage unit 140 for use with the computing device 100 in the relevant technical fields. The processor 130 reads applications stored in the storage unit 140 such as the first application 200, second application 300, and the service platform 400 in order to execute them. The computing device 100 may be a personal computer, a smartphone, a notebook computer, and a commercial server for a business purpose.

In the present specification, the term “application” may refer to a set of commands executed in the computing device 100, and may also be referred to as, for example, software, a program, a service, and an app. One of ordinary skill in the art would appreciate that the term, “application” may not be limited thereto in other embodiments.

The first application 200, the second application, and the service platform 400 have been prepared using standards for the method of sharing contents of the present invention from among applications. An example of the standards for the method of sharing contents according to the present invention is Backend as a Service (BaaS) standard, which has been developed by the applicant of the present patent application according to the technological competitiveness reinforcement program for small and medium sized companies of Korea Communications Agency.

Furthermore, in other embodiments, the method of sharing contents according to the present invention may be implemented with the first application 200 and the second application 300 which may not follow the standard for the method of sharing contents according to the present invention.

In one embodiment, the first application 200 and the second application 300 may be different, for instance, each application can be one of an e-mail application, a memo application, a scheduling (calendar) application, an address book application, a messenger application, and a task management application (also generally called “to-do management application”), and may be executed in the same computing device or in different computing devices, respectively. One of ordinary skill in the art would know that the present embodiment is not limited to this example. In other embodiments, the first application 200 and the second application 300 may be identical, for instance, each application can be one of the e-mail application, the memo application, the scheduling (calendar) application, the address book application, the messenger application, and the task management application, and may be executed in different computing devices, respectively. One of ordinary skill in the art would also know that the present invention is not limited to this example.

Furthermore, in the present specification, the term “contents” refers to electronic data which are input, stored, or read by an application, such as a text, image, GPS location information, and time information. One of ordinary skill in the art would know that the term, “contents” is not limited thereto in accordance with embodiments of the present invention.

First contents are stored in the first application 200. For example, when the first application 200 is a memo application, the first contents are electronic data stored in that memo application.

Thereafter, the computing device 100, more specifically, the service platform 400, analyzes first contents received in operation S100 so as to extract second contents to be shared with the second application 300 from among the first contents (S200).

Operation S200 will be described in detail below. FIG. 3 is a flowchart illustrating an example of operation S200 of the method of sharing contents according to an embodiment of the present invention as shown in FIG. 1.

Referring to FIG. 3, the first contents are analyzed according to the analysis criteria including at least one of a predetermined text set, a predetermined identifier, time information and location information which are provided by the computing device 100 (S210).

The analysis criteria will be described in detail below.

First, the case where the contents are analyzed based on the predetermined text set, i.e., contents awareness, will be described.

The predetermined text may include time (including the date), a name, a location (the name of place, address, etc.), a reason, a cause, and “to-do tasks”. In this case, for example, the paragraph or sentence identified by the text may be extracted as the second contents.

Furthermore, the context awareness will be described below. In this case, the analysis may be performed based on the time information, location information (GPS data, map information, etc.), etc. provided by the computing device 100 where applications have been installed. For example, the paragraph or sentence identified by the time information, location information, etc. may be extracted as the second contents.

Furthermore, the syntax analysis will be described below. In this case, for example, the identifier such as a tag is inserted into at least one of the front or back of a specific text, and the portion identified by the tag may be extracted as the second contents. A specific example will be described below. Thereafter, the second contents are extracted according to the analysis in operation S210 (S250). That is, the second contents are extracted from among the first contents.

The second contents may contain only the contents related with the second application 300 among the first contents. However, the second contents may be the same as the first contents.

Furthermore, operation S200 may include an operation of selecting the second application 300, according to the analysis criteria, from among a plurality of predetermined applications (S230). That is, when a plurality of predetermined applications is installed on the computing device 100, one application may be selected as the second application 300 according to the analysis criteria.

For example, when the first application 200 is a memo application, the first contents are electronic data stored by a memo application. If contents related with the scheduling exist in the first contents, the second application 300 is selected as the scheduling (calendar) application through the analysis according to operation S210. The selection of the second application is not limited to the above example.

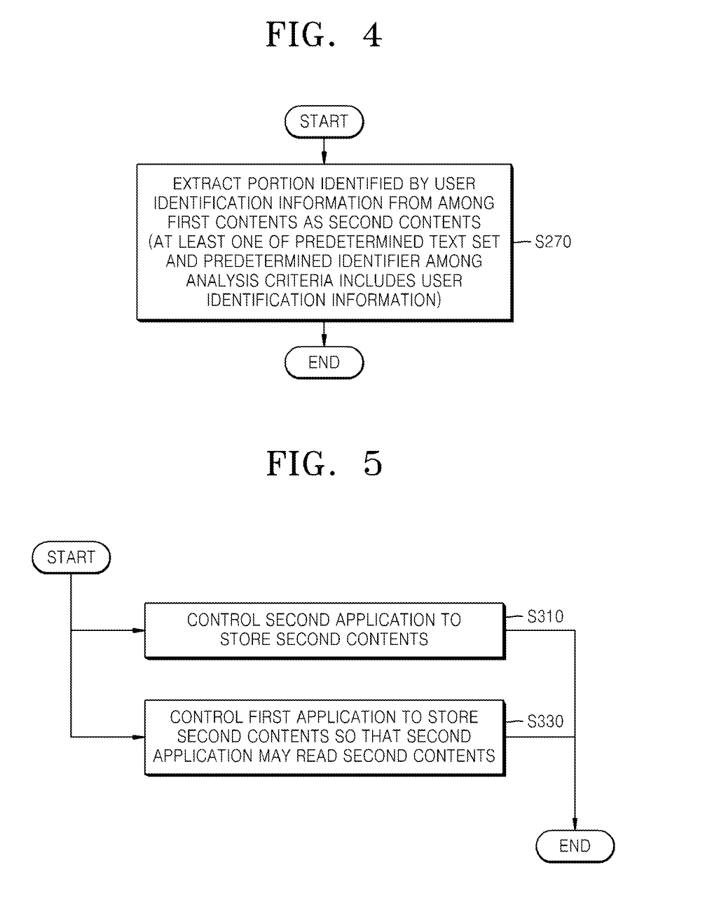

FIG. 4 is a flowchart illustrating another example of operation S200 of the method of sharing contents according to an embodiment of the present invention as shown in FIG. 1.

FIG. 4 illustrates an embodiment where at least one of a predetermined text set and a predetermined identifier contains user identification information.

As shown in FIG. 4, operation S200 may further include an operation of extracting a portion identified by user identification information from among the first contents as the second contents (S270). For example, the first application 200 is a memo application, and the first contents are electronic data stored by a memo application. If contents corresponding to only a specific user exist among the first contents, the portion identified by the corresponding user identification information may be extracted as the second contents (S270). For example, when the first contents indicate the task contents about users A to D, only the contents corresponding to the user A are identified and are extracted as the second contents.

For example, it is assumed that the first contents are as follows. User A: Write project documents and submit the project documents to user B by Mar. 30, 2013. User B: Review the project documents and submits the reviewed project documents to user C by Apr. 5, 2013. User C: Final review of the project documents by Apr. 10, 2013. In this case, the contents corresponding to user A are “Write project documents and submit the project documents to user B by Mar. 30, 2013.”

Hence, in operation S270, for example, the “Write project documents and submit the project documents to user B by Mar. 30, 2013” is extracted as the second contents for user A, and this is registered as the task schedule of user A through the scheduling (calendar) application which is the second application 300.

Furthermore, for example, the “Write project documents and submit the project documents to user B by Mar. 30, 2013” may be extracted as the second contents for user A from among the first contents, and then an e-mail application which is the second application 300 is selected. Thereafter, the second contents may be transmitted to the e-mail address of user A through the e-mail application.

Referring back to FIG. 1, thereafter, the computing device 100, more specifically, the service platform 400 shares the second contents extracted in operation S200 with the second application 300 (S300).

FIG. 5 is a flowchart illustrating an example of operation S300 of the method of sharing contents according to an embodiment of the present invention. Referring to FIG. 5, the schemes of sharing the second contents with the second application 300 may be divided into two schemes. First, operation S300 may include an operation of controlling the second application 300 to store the second contents (S310). That is, this is a case where the second application 300 directly stores the second contents.

In operation S310, the second contents are physically transmitted to the second application 300 and are stored through the second application 300. That is, the second application 300 directly stores the second contents through the physical transmission.

In another example, operation S300 may include an operation of controlling the first application 200 to store the second contents (S330) so that the second application 300 may read the second contents. That is, the second application 300 does not directly store the second contents. Instead, the second contents are stored in a storage unit corresponding to the first application 200 by the first application 200, and the second contents in the storage unit corresponding to the first application 200 are shared with the second application 300. This is referred to as a logical transmission. That is, the second application 300 does not directly store the second contents.

Furthermore, a user verification of a predetermined format may be needed to share the second contents with the second application 300 in operation S300. To this end, the method of sharing contents according to the present invention may further include an operation of receiving the user verification for sharing the second contents with the second application (S400).

That is, for example, if the first application 200 is a memo application, and the user verification is received before sharing the second contents with the second application 300, for example, the scheduling (calendar) application, from among the first contents, the memo information is stored by the memo application. The user verification is input by, for example, the user of the first application 200.

The second contents may be shared after verifying whether the second contents have been accurately extracted from the first contents and the second application has been accurately selected through user verification. Hence, the error according to the extraction and sharing of the second contents may be minimized.

In the present embodiment described with reference to FIGS. 1 to 5, the first application 200, the second application 300, and the service platform 400 are executed within the computing device 100. In other embodiments, the first application 200, the second application 300, and the service platform 400 may be executed within the computing device 100 and other computing device.

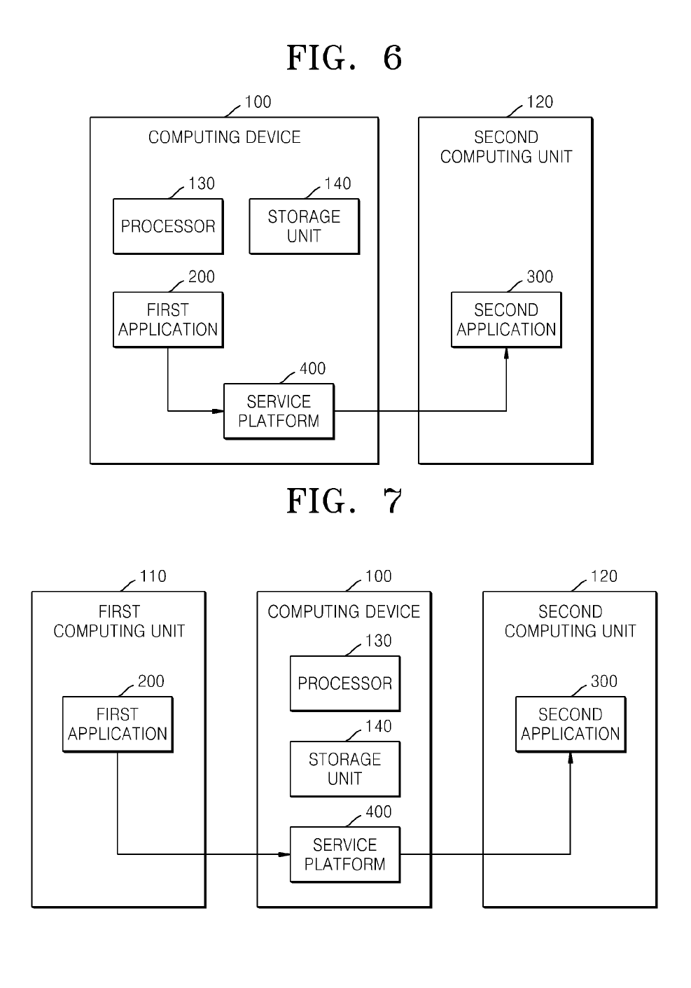

FIGS. 6 and 7 illustrate another system environment in which the method of sharing contents is applied according to an embodiment of the present invention. FIG. 6 shows an embodiment which uses two computing devices including the computing device 100 and a second computing unit 120. FIG. 7 shows an embodiment which uses three computing devices including the computing device 100, the first computing device 110 and the second computing device 120. Each computing device includes a processor and a memory suitable for performing the operations described in the embodiments as discussed herein.

Referring to FIG. 6, the first application 200 and the service platform 400 are executed in the computing device 100, and the second application 300 is executed in a second computing unit 120.

Referring to FIG. 7, the service platform 400 is executed in the computing device 100, the first application 200 is executed in a first computing unit 110, and the second application 300 is executed in the second computing unit 120.

The method of sharing contents according to the present invention may be applied even in the system environment illustrated in FIGS. 6 and 7.

In particular, when the first application 200 and the second application 300 are prepared according to the predetermined contents sharing standards, the method of sharing contents according to the present invention may be applied even in the system environment illustrated in FIGS. 6 and 7.

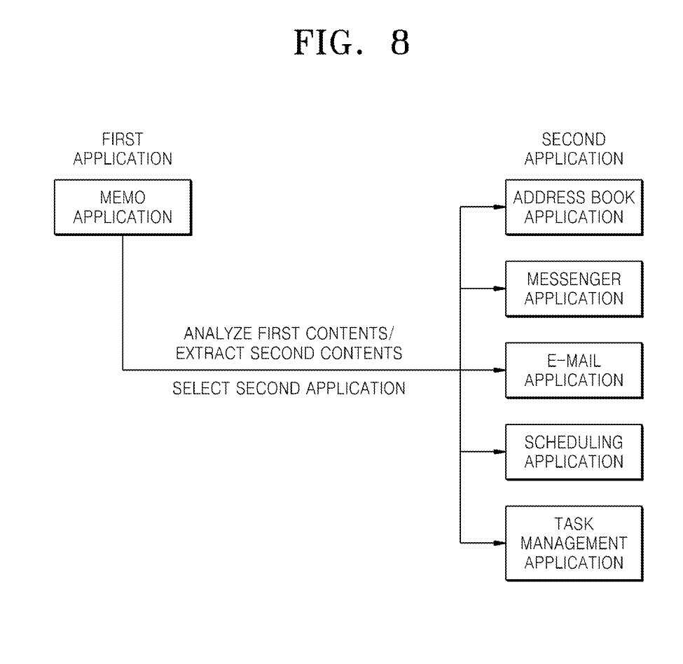

An example of the predetermined standards for the method of sharing contents according to the present invention is Backend as a Service (BaaS) standard which has been developed by the applicant of the present patent application according to the technological competitiveness reinforcement program for small and medium sized companies of Korea Communications Agency. In other embodiments, the first application 200 and the second application 300 may not follow the BaaS standard, and the service platform 400 receives the first contents from the first application 200 and transmit the second contents to the second application 300 (including physical transmission and logical transmission). FIG. 8 illustrates a matching relation between a first application and a second application according to the method of sharing contents according to an embodiment of the present invention.

When the first application is, for example, a memo application, the second application may be one or more of an address book application, a messenger application, an e-mail application, a scheduling (calendar) application, and a task management application.

That is, if a portion corresponding to the scheduling exists in a memo which is the first contents, the second application may become a scheduling (calendar) application, and if a portion corresponding to an e-mail exists in a note which is the first contents, the second application may become an e-mail application.

Hence, a plurality of second applications may be matched to one first application through the first contents analysis and the second contents extraction process.

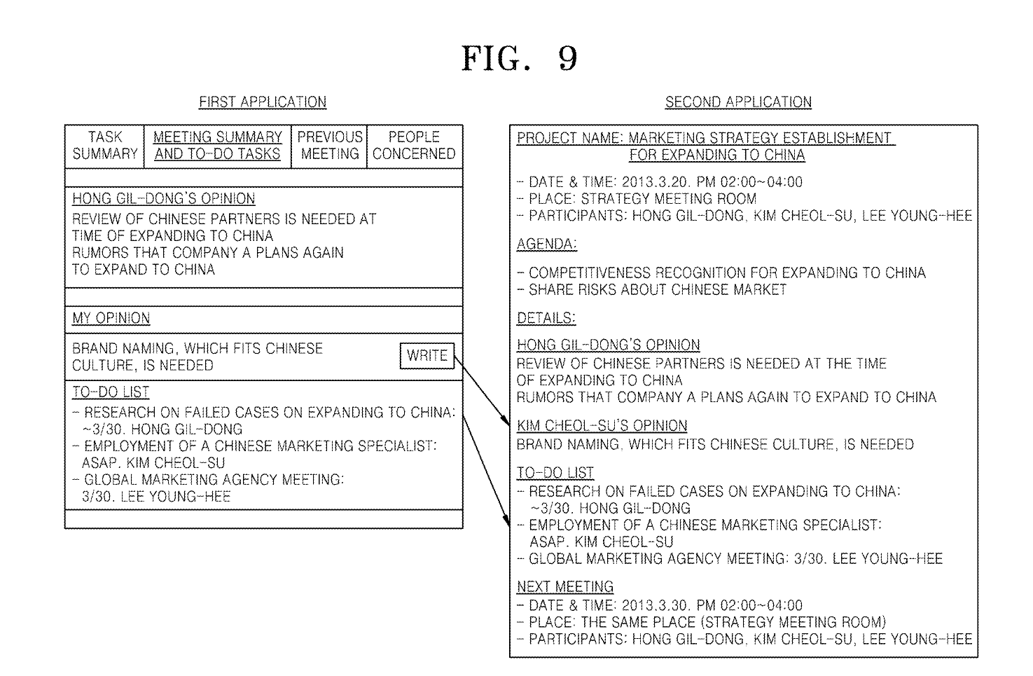

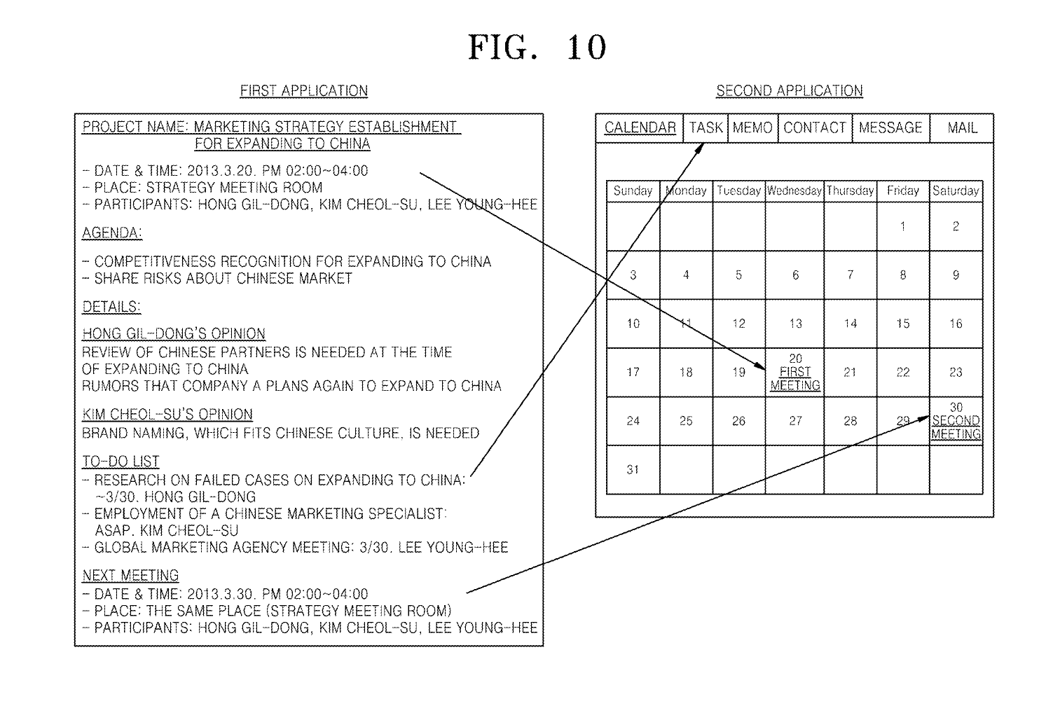

FIGS. 9 and 10 illustrate an example of sharing contents between the first application and the second application according to an embodiment of present invention. The process of extracting the second contents according to the analysis criteria in the method of sharing contents of the present invention will be described in detail with reference to FIGS. 9 and 10.

Referring to FIG. 9, a task management application of user Kim Cheol-Su (Kim is a last name and Cheol-Su is a first name) is set as the first application, and a meeting record application is set as the second application.

The task management application of the user, Kim Cheol-Su receives and displays another person's opinion, for example, Hong Gil-Dong's opinion (Hong is a last name and Gil-Dong is a first name). Furthermore, the user's own opinion or to-dos lists may be written and saved.

If the user, Kim Cheol-Su arranges task matters using his task management application, the contents are analyzed according to the method of sharing contents according to the present invention.

As shown in FIG. 9, this embodiment may extract the portion, i.e. “BRAND NAMING, WHICH FITS CHINESE CULTURE, IS NEEDED” corresponding to “my opinion” and insert the “BRAND NAMING, WHICH FITS CHINESE CULTURE, IS NEEDED” into the portion, “Kim Cheol-Su's opinion” as the second contents in the second application, by analyzing the first contents.

In this case, the second contents may be extracted as a scheme of analyzing the text or using a predetermined tag. That is, the analysis may be performed based on the text “MY OPINION”, or a tag format such as <Kim Cheol-Su's opinion Start> “MY OPINION”, “BRAND NAMING, WHICH FITS CHINESE CULTURE, IS NEEDED” <Kim Cheol-Su's opinion End”> may be disclosed. Furthermore, the text analysis or a tag may be also used in the process of extracting the second contents.

Likewise, the item “To-Do List,”—RESEARCH ON FAILED CASES ON EXPANDING TO CHINA: ˜3/30. Hong Gil-Dong, —EMPLOYMENT OF A CHINESE MARKETING SPECIALIST: ASAP. KIM CHEOL-SU, —GLOBAL MARKETING AGENCY MEETING: 3/30. LEE YOUNG-HEE” of the first contents is extracted as the second contents and is then inserted into the corresponding item of the second application.

In the example of FIG. 9, the first application may be executed in a business-purpose computer of the user, Kim Cheol-Su, and the second application may be executed in a business-purpose server used by all members of the team.

Furthermore, referring to FIG. 10, the meeting record application for the entire team is set as the first application, and the task management application, the scheduling (calendar) application, and the memo application, etc. of user Hong Gil-Dong are respectively set as the second application.

If the meeting schedule, the agenda, the opinion, etc. are stored as the first contents in the first application, the first contents are analyzed, and the second contents about user Hong Gil-Dong are extracted.

For example, when the second application is the scheduling (calendar) application, the first contents are analyzed and respectively recorded as “FIRST MEETING” and “SECOND MEETING” on Mar. 20, 2013 and Mar. 30, 2013 disclosed in the first contents. As details of the “FIRST MEETING” and “SECOND MEETING”, for example, “DATE & TIME: 2013.3.20. PM 02:00˜04:00. —PLACE: STRATEGY MEETING ROOM, —PARTICIPANTS: HONG GIL-DONG, KIM CHEOL-SU, LEE YOUNG-HEE” and “DATE & TIME: 2013.3.30. PM 02:00˜04:00. —PLACE: THE SAME PLACE (STRATEGY MEETING ROOM), —PARTICIPANTS: HONG GIL-DONG, MM CHEOL-SU, LEE YOUNG-HEE” may be recorded.

For example, when the second application is the task management application, the item “—RESEARCH ON FAILED CASES ON EXPANDING TO CHINA: ˜3/30.” from among the “TO-DO LIST” portion of the first contents may be inserted in the second application as the second contents.

Furthermore, for example, when the second application is the memo application, all of the first contents may be inserted in the memo item of the second application as the second contents.

In the example of FIG. 10, the first application may be executed in the business-purpose server used by the entire team, and the second application may be executed in the business-purpose computer of the user, Hong Gil-Dong.

As described above, according to the above-described embodiments of the present invention, even if contents are written using one application, the contents may be analyzed and then shared with other applications, and thus, the user may not need to separately input contents for each application.

Furthermore, when a plurality of users is present, the contents may be shared in a manner customized for each user, and thus, the security of contents may be enhanced and the task performance efficiency may be improved.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

We claim:

1. A method of sharing contents performed in a computing device, the method comprising:
receiving first contents stored by a first application;
analyzing the first contents according to predetermined criteria;
extracting second contents which meet the predetermined criteria from among the first contents; and
sharing the second contents with a second application.

2. The method of claim 1, further comprising:
receiving a user verification for the second contents before sharing the second contents with the second application.

3. The method of claim 1, wherein the step of analyzing the first contents comprises:
analyzing the first contents according to analysis criteria including at least one of a predetermined text set, a predetermined identifier, time information, or location information provided in the computing device.

4. The method of claim 3, further comprising:
selecting the second application according to the analysis criteria from among a plurality of predetermined applications.

5. The method of claim 3, wherein the predetermined text set, the predetermined identifier, or both include user identification information, and
the step of extracting of the second contents comprises:
extracting as the second contents a portion identified by the user identification information from among the first contents.

6. The method of claim 5, wherein the first application is executed in a first computing device, and the second application is executed in a second computing device.

7. The method of claim 1, wherein the step of sharing of the second contents comprises:
controlling the second application to store the second contents.

8. The method of claim 1, wherein the step of sharing of the second contents comprises:
controlling the first application to store the second contents;
permitting the second application to access the second contents.

9. The method of claim 1, wherein the first application, the second application, or both comprise one of an e-mail application, a memo application, a scheduling or calendar application, an address book application, a messenger application, and a task management application.

10. The method of claim 1, wherein the first application and the second application are prepared according to a predetermined contents sharing standard.

11. The method of claim 1, further comprising executing the first application with a first computing unit other than the computing device.

12. The method of claim 1, further comprising executing the second application with a second computing unit other than the computing device.
